(19) United States
(12) Patent Application Publication
(10) Pub. No.: US 2023/0401340 A1
(43) Pub. Date: Dec. 14, 2023

(54) APPLICATION-SPECIFIC INTEGRATED CIRCUIT (ASIC) WITH ONE-TIME PROGRAMMABLE (OTP) BITS

(71) Applicant: Hewlett-Packard Development Company, L.P., Spring, TX (US)

(72) Inventor: Gary M. Nobel, San Diego, CA (US)

(21) Appl. No.: 17/840,182

(22) Filed: Jun. 14, 2022

(51) Int. Cl. G06F 21/72; G06F 21/60; G06F 21/31; G06F 21/57

(52) U.S. Cl. CPC G06F 21/72; G06F 21/602; G06F 21/31; G06F 21/575

(57) ABSTRACT

Values are received for one-time programmable (OTP) bits of an application-specific integrated circuit (ASIC) that are unprogrammed. The ASIC has one or multiple processors that are disabled. The OTP bits of the ASIC are programmed with the received values. The OTP bits after having been programmed govern which and whether instructions are executable by the ASIC. Future reprogramming of the OTP bits of the ASIC is disabled. In response to successful programming of the OTP bits and successful disabling of future reprogramming of the OTP bits, the processors of the ASIC are enabled.

### BACKGROUND

Electronic and electromechanical devices, including printing devices such as standalone printers and all-in-one (AIO) devices that in addition to printing functionality have scanning, copying, and/or faxing functionality, include a variety of specialized components. The devices are usually assembled in a different facility from that in which at least some of the specialized components are fabricated. For example, application-specific integrated circuits (ASICs) may be fabricated at a separate semiconductor fabrication facility before being transported to an assembly facility in which devices including the ASICs are manufactured.

### BRIEF DESCRIPTION OF THE DRAWINGS

FIG. 1 is a diagram of an example overall process in which application-specific integrated circuits (ASICs) are fabricated in a different facility from that in which devices including the ASICs are assembled.

FIG. 2 is a diagram of an example ASIC having one-time programmable (OTP) bits.

FIG. 3 is a flowchart of an example method for programming OTP bits of an ASIC, and not enabling processors of the ASIC until the OTP bits have been programmed.

FIG. 4 is flowchart of an example method for controlling whether OTP bits of an ASIC can be programmed.

FIG. 5 is a diagram of an example non-transitory computer-readable data storage medium storing program code executable by processors of an ASIC that have been enabled.

### DETAILED DESCRIPTION OF THE DRAWINGS

An application-specific integrated circuit (ASIC) is an IC that is customized for a particular use, rather than intended for general-purpose use as is the case with a general-purpose processor such as a central processing unit (CPU). ASICs are fabricated within specialized semiconductor fabrication facilities. Once the ASICs have been fabricated within such a fabrication facility, they can be transported to a different manufacturing facility at which devices including the ASICs, such as printing devices, are assembled.

An ASIC can have security features to ensure that the ASIC runs only approved instructions after assembly within a device. For example, the ASIC may have a public cryptographic key programmed therein, which is one example of an authorization or authentication signature. A processor, such as the boot processor that executes instructions before any other processor of the ASIC can do so, first verifies that instructions have been signed with a corresponding private cryptographic key before executing the instructions. The private key is securely maintained by an authorized party, such as the device manufacturer, and ensures that the ASIC can only execute instructions approved by that party.

However, because ASICs are fabricated within a different facility than the facility within which end devices of which the ASICs are a part are manufactured, malfeasance or negligence can result in security vulnerabilities. ASICs may accidentally exit the fabrication facility before they have been programmed with an approved authentication or authorization signature, or a nefarious party within the fabrication facility may divert ASICs from the facility before they have been so programmed. Such ASICs are otherwise operable, and if assembled into devices may be able run instructions unapproved by the device manufacturer. The ASICs may be programmed with a different signature, such as that of a nefarious party, to permit the nefarious party to have ASICs within devices run instructions of the party's choosing.

Furthermore, public-private key cryptography in particular has been shown to be vulnerable to quantum computing techniques. A nefarious party who has access to quantum computing resources can therefore overcome the security afforded by public-private key cryptography to cause an ASIC within a device to execute instructions of its own choosing. This means that even an ASIC that has left the fabrication facility properly programmed with the approved authentication or authorization signature of the device manufacturer is nevertheless vulnerable in its ability to execute only manufacturer-approved instructions after assembly within a device.

Techniques described herein ameliorate these and other issues. An ASIC includes one-time programmable (OTP) bits that can be also referred to as cryptographic value OTP bits. The OTP bits can be programmed with values that are robust against quantum computing attacks. For instance, these OTP bits may be a SHA-256 cryptographic digest generated using the SHA-256 cryptographic hashing algorithm, and which is generally considered to be resistant to quantum computing attacks. The boot processor of the ASIC only executes instructions that have values (e.g., a cryptographic digest) matching those programmed into these digest OTP bits. That is, the OTP bits after having been programmed govern which and whether instructions are executable by the ASIC

Furthermore, until the OTP bits of the ASIC have been programmed with values, the processors of the ASIC are disabled. That is, the ASIC is fabricated so that the processors are initially disabled and thus inoperable. Only after the OTP bits have been programmed are the processors subsequently enabled.

This means that, in general, an ASIC leaving the semiconductor fabrication facility is in one of two states. First, the ASIC may have had its digest OTP bits programmed and its processors enabled. In this case, upon assembly into a device, the ASIC will execute just device manufacturer-approved code, since the OTP bits are programmed with manufacturer-specific values within the fabrication facility.

Second, the ASIC may leave the fabrication facility without having had its OTP bits programmed, either purposefully (e.g., nefariously) or accidentally. However, because the ASIC did not have its OTP bits programmed, the processors of the ASIC remain disabled. As a result, the ASIC is inoperable, and will not be able to execute any instructions if assembled into a device. Therefore, the usefulness of such an ASIC to a nefarious party is limited.

However, a sophisticated nefarious party may have access to the same tool used in the fabrication facility to program the OTP bits (and thus to enable the processors of the ASIC). This means that such a party, if able to divert OTP bit-unprogrammed and processor-disabled ASICs from the fabrication facility, would nevertheless be able to program the OTP bits within its own values. Therefore, if assembled into a device, the ASIC would execute instructions as dictated by the nefarious party, instead of manufacturer-approved instructions.

The techniques described herein provide for a specialized process by which to program the OTP bits to defend against such an ASIC attack vector. In particular, an ASIC may have an ASIC-specific value that is readable even when the processors of the ASIC are disabled. For successful programming of the OTP bits, the ASIC-specific value is first read, and an authentication value calculated based on this value, which is then provided to the ASIC. The ASIC's OTP bits are programmable only if the provided authentication value matches a value that the ASIC expects.

This process reduces the likelihood that a sophisticated nefarious party that has access to the same tool used in the fabrication facility to program the OTP bits of an ASIC from successfully programming the OTP bits. Even if the party is able to divert an OTP bit-unprogrammed and processor-disabled ASIC from the fabrication facility, the party would have to know both how to read the ASIC-specific value and how to calculate an authentication value from this value in order to successfully program the OTP bits. Even if the party knows just how to read the ASIC-specific value or just how to calculate the authentication value from this value, the party would still be unsuccessful in programming the OTP bits of the ASIC.

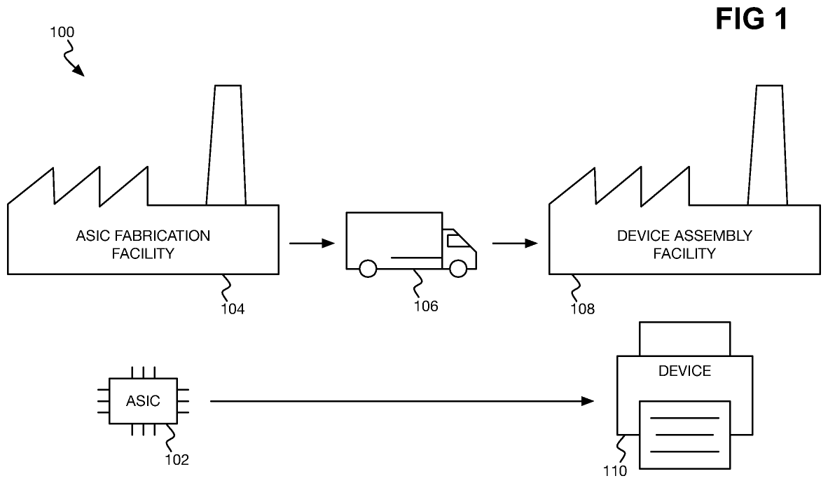

FIG. 1 shows an example overall process 100 in which ASICs 102 are manufactured vis-à-vis the electronic or electromechanical devices 110 (which in the example are specifically printing devices) within which the ASICs 102 are assembled. Specifically, the ASICs 102 are manufactured at an ASIC fabrication facility 104, which may be a specialized semiconductor fabrication facility. Upon being manufactured and released from the fabrication facility 104, the ASICs 102 are shipped, such as via truck 106, to a separate device assembly facility 108 at which the devices 110 are assembled or otherwise manufactured. The device assembly facility 108 may be at a physically distant location than the ASIC fabrication facility 104. The fabricated ASICs 102 are thus assembled into the devices 110 at the assembly facility 108.

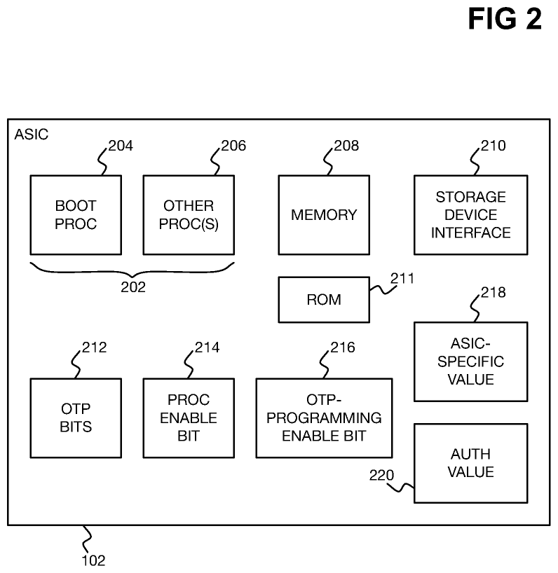

FIG. 2 shows an example ASIC 102. The ASIC 102 can include one or multiple processors 202. The processors 202 include at least a boot processor 204, and can include one or multiple other processors 206 as well. The boot processor 204 is the processor that executes instructions before any other processor 206 of the ASIC 102 is able to execute (other) instructions.

The ASIC 102 can include or be connected to volatile memory 208, such as volatile semiconductor memory such as dynamic-random access memory (DRAM). The ASIC 102 can include a storage device interface 210 to permit communicative connection of a storage device to the ASIC 102 that stores instructions executable by the processors 202. The storage device interface 210 may be a slot or socket permitting physical coupling of a nonvolatile memory card or chip (or other storage device) to the ASIC 102 for loading of instructions stored on the storage device into the memory 208 for execution by the processors 202. In another implementation, the nonvolatile memory card or chip may be soldered to the same logic board as the ASIC 102, in which case the storage device interface 210 may be considered the internal wiring of the logic board that are connected to this storage device.

The ASIC 102 can include a non-volatile read-only memory (ROM) 211 that stores boot instructions (e.g., in the form of program code) for execution by the boot processor 204 in particular. An example of such a ROM 211 is described later in the detailed description, as a non-transitory computer-readable data storage medium more generally. The boot instructions stored on the ROM 211 direct the boot processor 204 to load and verify instructions stored on the storage device coupled to the storage device interface 210, and execute the instructions if verified. Execution of the instructions by the boot processor 204 may then result in the other processors 206 loading and executing other instructions from the storage device, for instance.

The ASIC 102 includes a number of OTP bits 212. The OTP bits 212 are stored in a secure non-volatile memory region of the ASIC 102. The OTP bits 212 can be programmed with values just once. That is, the non-volatile memory region of the ASIC 102 is not erasable or rewritable after having been rewritten. That is, this non-volatile memory region of the ASIC 102 may be in the form of links, that can be fused or burned together in an irreversible manner. The OTP bits 212 can be programmed with cryptographic values that are specific to the manufacturer of the device 110 in which the ASIC 102 may be assembled.

For example, the cryptographic values may constitute a cryptographic signature corresponding to the content of the storage device and to a private cryptographic key that is known only to the manufacturer and its approved parties. As another example, the cryptographic values may constitute a cryptographic digest that is more resistant if not impervious against quantum computing attacks. For example, the values may represent a SHA-256 cryptographic digest generated using the SHA-256 cryptographic hashing algorithm.

The ASIC 102 can include a processor enable bit 214. The processor enable bit 214 can be stored in a non-volatile memory region of the ASIC 102, and is also an OTP bit in that it is able to be programmed once and is not erasable or rewritable. The processor enable bit 214 is set to true to enable the processors 202, once the OTP bits 212 have been programmed. The processor enable bit 214 may not be able to be set to true if the OTP bits 212 have not been programmed with values. The processor enable bit 214 may automatically be set to true when the OTP bits 212 are programmed. Until the processor enable bit 214 is set to true, the processors 202 remain disabled and inoperative and the ASIC 102 non-functional. Therefore, at initial fabrication of the ASIC 102, the OTP bits 212 are unprogrammed and the processor enable bit 214 indicates or is otherwise false by default.

The ASIC 102 may include an OTP-programming enable bit 216. The enable bit 216 can be stored in a non-volatile memory region of the ASIC 102, and is also an OTP bit in that it is able to be programmed once and is not erasable or rewritable. The enable bit 216 can be used to control whether the OTP bits 212 are programmable. For instance, at initial fabrication of the ASIC 102, the enable bit 216 is set to true, permitting the OTP bits 212 to be programmed with values. Once the OTP bits 212 have been programmed, the enable bit 216 is set to false to prevent the OTP bits 212 from being erased or reprogramed. The enable bit 216 may automatically be set to false when the OTP bits are programmed. Until the enable bit 216 is set to false, the OTP bits 212 can be programmed.

The ASIC 102 may include an ASIC-specific value 218 and/or a corresponding authorization value 220. The ASIC-specific value 218 and the corresponding authorization value 220 may be stored in a secure non-volatile memory region of the ASIC 102. The ASIC-specific value 218 is accessible and readable outside of the ASIC 102, whereas the authorization value 220 is not accessible nor readable outside of the ASIC 102. The ASIC-specific value 218 is a value that is specific to the ASIC 102 itself, and may be at least substantially unique to each ASIC 102. The ASIC-specific value 218 may be a serial number, for instance.

The authorization value 220 is a value that is generated based on or from the ASIC-specific value 218. The authorization value 220 may be generated by applying a cryptographic or other hashing algorithm or technique to the ASIC-specific value 218. The hashing algorithm may be a one-way hashing algorithm, in that the ASIC-specific value 218 is not determinable from the authorization value 220. The hashing algorithm may be a one-to-one, or substantially one-to-one, algorithm, in that different ASIC-specific values 218 may not result in generation of the same authorization value 220.

The authorization value 220 can control whether the OTP bits 212, the processor enable bit 214, and/or the OTP-programmable enable bit 216 can be programmed. Unless an authorization value matching the authorization value 220 stored in the ASIC 102 is provided, for instance, the bits 212, 214, and/or 216 are not able be programmed. As one example, the OTP bits 212 may be able to be programmed with values, but the processor enable bit 214 may not be able to be set to true unless an authorization value matching the authorization value 220 is provided. In this case, the OTP bits 212 could be programmed, but the processors 202 nevertheless still remain disabled.

In another implementation, the authorization value 220 may not be stored in the ASIC 102, but generated by the ASIC 102 when an authorization value is provided to the ASIC 102. In this case, the processor enable bit 214 may not be able to be set to true unless the provided authorization value matches the generated authorization value 220. As before, the OTP bits 212 could still be programmed, but the processors 202 remain disabled. In both implementations, then, the processor enable bit 214 may not be able to be set to true unless the provided authorization value matches the expected (e.g., previously stored or generated) authorization value 220.

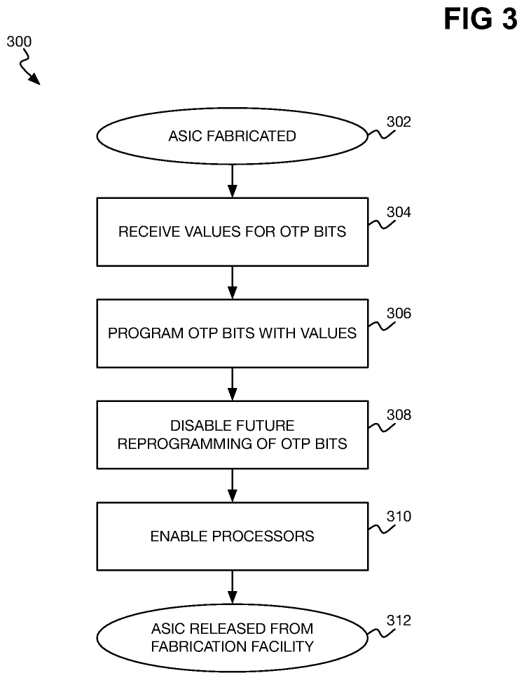

FIG. 3 shows an example method 300 for programming the OTP bits 212 of an ASIC 102, and not enabling the processors 202 of the ASIC 102 until the OTP bits 212 have been programmed. The method 300 is performed at the ASIC fabrication facility 104 after fabrication of the ASIC 102 and prior to release of the ASIC 102 from the facility 104 for transport to the device assembly facility 108. The method 300 can be performed using a specialized ASIC-programming equipment, such as a tool. Such a tool may be able to perform the method 300 on multiple ASICs 102 in parallel, or sequentially.

Upon the ASIC 102 having been fabricated (302), the processors 202 are initially in a disabled state and the OTP bits 212 have not been programmed. Therefore, if the ASIC 102 includes a processor enable bit 214 and/or the OTP-programming enable bit 216, the enable bit 214 is initially set to false (to disable the processors 202) and the enable bit 216 is initially set to true (to permit programming of the OTP bits 212) at fabrication. By comparison, the ASIC-specific value 218 and the authentication value 220, if present, are stored or programmed into the ASIC 102 at time of fabrication.

The method 300 includes receiving values for the OTP bits 212 (304). As has been noted, the values are specific to the manufacturer of the device 110, and can represent a cryptographic value such as a cryptographic signature or a cryptographic digest of or for the device manufacturer. The method 300 includes programming the OTP bits 212 with the received values (306). Once programmed with values, the OTP bits 212 govern whether the boot processor 204 executes instructions loaded from a storage device coupled to the storage device interface 210, and thus whether any other processor 206 can execute other instructions loaded from the storage device, as described later in the detailed description.

The method 300 includes disabling future reprogramming of the OTP bits 212 (308). In one implementation, such disabling is automatic or inherent to programming of the OTP bits 212. That is, the physical nature of the non-volatile region of the ASIC 102 in which the OTP bits 212 are stored may preclude the OTP bits 212 from being reprogrammed. In another implementation, such disabling occurs by permanently setting an OTP-programming enable bit 216 to false, which governs whether the OTP bits 212 can be programmed (and thus reprogrammed). The OTP-programming enable bit 212 may be set to false automatically with the programming of the OTP bits 212.

The method 300 includes, in response to successfully programming the OTP bits 212 and successfully disabling future reprogramming of the OTP bits 212, enabling the processors 202 of the ASIC 102 (310). In one implementation, such enabling occurs by permanently setting the processor enable bit 214 to true, which governs whether the processors 202 are enabled and thus operative. That is, the architectural design of the ASIC 102 is such that the processors 204 are disabled and inoperative (and the ASIC 102 non-functional) unless the enable bit 214 is set to true. The processor enable bit 214 may be set to true automatically with the programming of the OTP bits 212.

Once the method 300 has been performed, the ASIC 102 can then be released from the fabrication facility 104 (312), and thus transported to the assembly facility 108 for inclusion within a device 110. Upon being released from the fabrication facility 104, if the method 300 has been performed, the ASIC 102 has its OTP bits 212 programmed with values in such a way that the bits 212 cannot be reprogrammed or erased, and the processors 202 are enabled. If the ASIC 102 is purposefully (e.g., nefariously) or accidentally released without the method 300 having been performed after fabrication, the ASIC 102 is generally unusable, because the processors 202 are disabled.

However, a sophisticated nefarious party may nevertheless still be able to use the ASIC 102 even if released from the fabrication facility 104 without the method 300 having been performed, and thus even though the processors 202 are disabled. Specifically, a nefarious party having access to the same ASIC-programming equipment as that which is used within the facility 104 to perform the method 300 may in be theory able to program the OTP bits 212 with its own values to enable the processors 202 and permit the party to control which instructions the boot processor 204 executes. Therefore, what follows is description of a technique to lessen the likelihood of such a nefarious party from being successful in this regard.

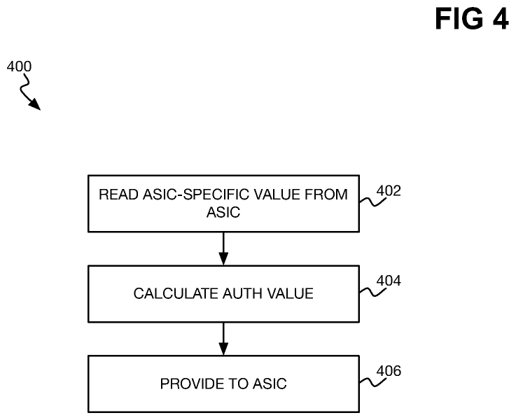

FIG. 4 shows an example method 400 that can be used in conjunction with the method 300 for controlling whether the OTP bits 212 and/or the processor enable bit 214 (which is another type of OTP bit) can be programmed (e.g., set). The method 400 is performed in an implementation in which the ASIC 102 at fabrication includes the ASIC-specific value 218 and the authentication value 220. As noted, the authentication value 220 is generated by applying a specific cryptographic hashing or other technique to the ASIC-specific value 218. The identity of the specific hashing technique (i.e., which technique is used) may be known only to the device manufacturer and its approved parties.

The method 400 can be performed prior to part 306 and/or part 310 of the method 300, or within part 306 and/or part 310. That is, the OTP bits 212 may be successfully programmed with provided values only after the method 400 has resulted in generating the authentication value 220 internal to the ASIC 102. Similarly—i.e., additionally or instead—the processor enable bit 214 may be successfully set to true only after the method 400 has resulted in generation of the authentication value 220.

The method 400 includes reading the ASIC-specific value 218 from the ASIC 102 while the processors 202 remain disabled (402). For example, the ASIC-specific values 218 may be stored in the ASIC 102 in such a way that they can be read without involving the processor 202, which means that the values 218 can be read without the processors 202 having to be enabled. If a nefarious party does not know the process by which the ASIC-specific value 218 is readable, therefore, the party will not be able to program the OTP bits 212 and/or enable the processors 202.

The method 400 includes calculating an authentication value from the ASIC-specific value 218 that has been read (404). The authentication value is calculated in the same way in which the authentication value 220 stored in and irretrievable from the ASIC 102 was generated. If a nefarious party does not know the particular hashing algorithm technique used to generate the authentication value 220 the party will not be able to program the OTP bits 212 and/or enable the processors 202, even if the party is able to read the ASIC-specific value 218 from the ASIC 102.

Furthermore, in one type of hashing algorithm, the authentication value 220 is generated using an ASIC-specific value 218 and another value, which is known as “salt.” The salt is known just to the device manufacturer and its approved parties, and the same salt may be used for generating the authentication value 220 for every ASIC 102. Therefore, even if a nefarious party knows the particular hashing algorithm that is used, if the party does not know the salt, the party will not be able to program the OTP bits 212 and/or enable the processors 202, even if the party is able to read the ASIC-specific value 218.

The method 400 includes providing the calculated authentication value to the ASIC 102 (400). The ASIC 102 in turn permits the OTP bits 212 to be programmed and/or the processors 202 to be enabled just if the provided authentication value matches (e.g., is identical to) the authentication value 220 stored within the ASIC 102. If the provided authentication value does not match the stored authentication value 220, the ASIC 102 does not program the OTP bits 212 and/or does not enable the processors 202. Therefore, a nefarious party that is unable to generate the authentication value 220 will be unable to successfully program the OTP bits 212 and/or enable the processors 202.

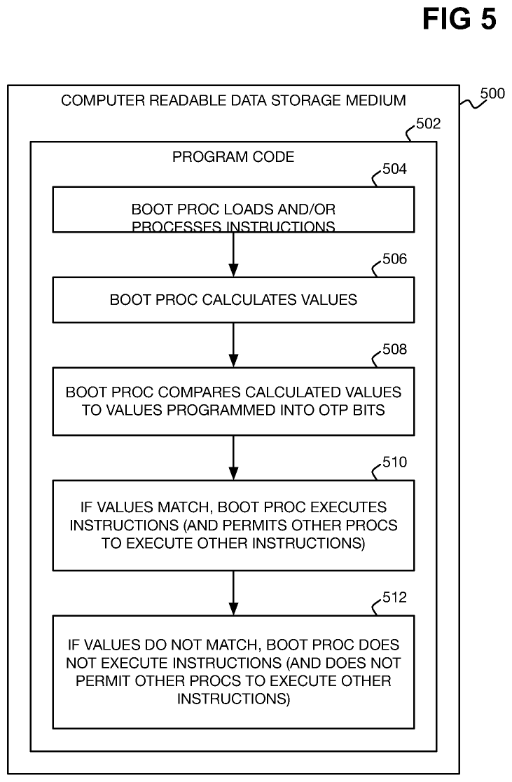

FIG. 5 shows an example non-transitory computer-readable data storage medium 500 storing program code 502 executable by the processors 202 of the ASIC 102 to perform processing. The computer-readable data storage medium 500 is a more general example of the described ROM 211 of the ASIC 102. The program code 502 thus can be stored within the ASIC 102 at time of fabrication. The program code 502 is executable after the processors 202 have been enabled, and thus after the OTP bits 212 have been programmed. For instance, the program code 502 may be executed as boot instructions after the ASIC 102 has been assembled into a device 110.

The processing includes the boot processor 204 loading and/or processing but not executing instructions from a storage device coupled to the storage device interface 210 (504). The processing includes the boot processor 204 then calculating values from or based on the loaded instructions (506). As one example, the instructions may have been digitally signed with a private cryptographic key such that the signature matches the value stored within the OTP bits 212. As another example, the boot processor 204 may perform a cryptographic hashing algorithm on the instructions or a portion thereof to generate a cryptographic digest. For instance, the boot processor 204 may apply the SHA-256 algorithm to the instructions to generate an SHA-256 digest.

The processing includes the boot processor 204 comparing the calculated values with the values previously programmed into the OTP bits 212 to determine if the calculated values match the values programmed into the OTP bits 212 (508). In the case of public-private key authentication, the boot processor 204 may as part of this comparison use the public key encoded within the OTP bits 212 to verify that the instructions have been digitally signed with the corresponding private key. In the case of a cryptographic digest, the boot processor 204 may as part of this comparison verify that the cryptographic digest calculated based on the instructions is identical to the digest encoded within the OTP bits 212.

The processing includes, if the calculated values match the programmed values, the boot processor 204 executing the instructions that have been loaded from the storage device coupled to the storage device interface 210 (510). Such execution can result in the boot processor 204 passing control to other processors 206, and thus permitting other processors 206 to load and execute other instructions from the storage device. As another example, such execution can result in further instruction authentication being performed in a cascading chain of trust, where the initially loaded set of instructions once authenticated convey trust to a subsequently loaded set of instructions, which once authenticated convey trust to another subsequently loaded set of instructions, and so on.

The processing includes, if the calculated values do not match the programmed values, the boot processor 204 not executing the instructions that have been loaded from the storage device (510). In this case, the boot processor 204 does not permit any other processor 204 to execute other instructions, such that no other processor 206 can execute other instructions. Therefore, the OTP bits 212 (specifically the values programmed therein) govern whether the boot processor 204 executes loaded instructions, and whether any other processor 206 can execute other instructions.

Techniques have been described for rendering ASICs 102 less susceptible to security vulnerabilities. When an ASIC 102 leaves the ASIC fabrication facility 104, the ASIC 102 may be in one of two states. First, the processors 202 may have been enabled and the OTP bits 212 programmed with device manufacturer-specific values that ensure that the processors 202 can execute just manufacturer-approved instructions. Therefore, such an ASIC 102 is less likely to be maliciously used by a nefarious party. Second, the processors 202 may be disabled. In this case, such an ASIC 102 is also less likely to be maliciously used by all but more sophisticated nefarious parties that have access to the same equipment for programming the OTP bits 212 as that which is used within the fabrication facility 104.

Furthermore, techniques have been described herein for rendering ASICs 102 less susceptible to even these security vulnerabilities. Specifically, the techniques can limit programming of the OTP bits 212 and the processor enable bit 216 only if an ASIC-specific value 218 is known how to be read and a corresponding authentication value 220 is known how to be calculated from the value 218. Finally, because the OTP bits 212 are not limited to any particular type of cryptographic authentication values, the described ASIC 102 is futureproof insofar as when an existing way by which the values programmed into the OTP bits 212 are generated has been compromised, the OTP bits 212 of future ASICs 102 can be programmed with values generated in a different manner.

We claim:

1. A method comprising:
receiving values for a plurality of one-time programmable (OTP) bits of an application-specific integrated circuit (ASIC) that are unprogrammed, the ASIC having one or multiple processors that are disabled;
programming the OTP bits of the ASIC with the received values, the OTP bits after having been programmed governing which and whether instructions are executable by the ASIC;
disabling future reprogramming of the OTP bits of the ASIC; and
in response to successfully programming the OTP bits and successfully disabling future reprogramming of the OTP bits, enabling the processors of the ASIC.

2. The method of claim 1, wherein the processors of the ASIC comprise a boot processor that executes the instructions before any other processor of the ASIC can execute other instructions,
and wherein the OTP bits govern whether the boot processor executes the instructions after loading the instructions, and whether any other processor can execute the other instructions.

3. The method of claim 2, wherein the boot processor, after loading the instructions, calculates values based on the instructions, and executes the instructions just if the calculated values match the values with which the OTP bits have been programmed.

4. The method of claim 1, further comprising:
reading an ASIC-specific value from the ASIC while the processors are disabled;
calculating an authentication value based on the ASIC-specific value; and
providing the calculated authentication value to the ASIC,
wherein the processors of the ASIC can be enabled just when the calculated authentication value matches an authentication value expected by the ASIC.

5. The method of claim 1, wherein enabling the processors of the ASIC comprises:
permanently setting a processor enable bit to true.

6. The method of claim 1, wherein disabling future reprogramming of the OTP bits of the ASIC comprises:
permanently setting an OTP-programming enable bit to false.

7. A non-transitory computer-readable data storage medium storing program code executable by one or multiple processors of an application-specific integrated circuit (ASIC) to perform processing comprising:
loading, by a boot processor of the processors of the ASIC, instructions, the processors having been enabled via a processor enable bit of the ASIC having previously been set to true;
calculating, by the boot processor, values based on the loaded instructions;
comparing, by the boot processor, whether the calculated values match values with which one-time programmable (OTP) bits of the ASIC have been previously programmed;
in response to the calculated values matching the values with which the OTP bits have been previously programmed, executing, by the boot processor, the loaded instructions.

8. The non-transitory computer-readable data storage medium of claim 7, wherein the processing further comprises:
in response to the calculated values not matching the values with which the OTP bits have been previously programmed, not executing, by the boot processor, the loaded instructions.

9. The non-transitory computer-readable data storage medium of claim 7, wherein the boot processor has to execute the instructions before any other processor of the ASIC can execute other instructions,
and wherein the OTP bits govern whether the boot processor executes the instructions after loading the instructions, and whether any other processor can execute the other instructions.

10. The non-transitory computer-readable data storage medium of claim 7, wherein the processing further comprises:
subsequent to execution of the instructions by the boot processor, executing, by another processor of the processors of the ASIC, other instructions.

11. An application-specific integrated circuit (ASIC) comprising:
one or multiple processors, including a boot processor that executes instructions before any other processor can execute other instructions;
a plurality of one-time programmable (OTP) bits that cannot be reprogrammed after having been programmed with values, the OTP bits after having been programmed governing which and whether the instructions are executable; and
a processor enable bit that is not set to true to enable the processors until the OTP bits have been programmed with the values.

12. The ASIC of claim 11, wherein the OTP bits are programmed with the values and the processor enable bit is set to true, such that the ASIC is functional,
wherein the OTP bits govern whether the boot processor executes the instructions after loading the instructions, and whether any other processor can execute the other instructions
and wherein the boot processor, after loading the instructions, calculates values based on the instructions, and executes the instructions just if the calculated values match the values with which the OTP bits have been programmed.

13. The ASIC of claim 11, wherein the OTP bits are not programmed with any values and the processor enable bit is false by default, such that the ASIC is non-functional.

14. The ASIC of claim 11, further comprising:
an ASIC-specific value that is readable while the processors are disabled; and
an authentication value based on the ASIC-specific value,
wherein the processor enable bit cannot be set to true until the authentication value has been provided.

15. The ASIC of claim 11, further comprising:
an OTP-programming enable bit that is set to false to disable future reprogramming of the OTP bits once the OTP bits have been programmed with the values.
